(19) United States
(12) Patent Application Publication
(10) Pub. No.: US 2009/0000352 A1
(43) Pub. Date: Jan. 1, 2009

(54) GAS SENSING ELEMENT WITH INCREASED MECHANICAL STRENGTH

(75) Inventors: Kazuhiko Koike, Okazaki-shi (JP); Akio Tanaka, Gifu-shi (JP)

Correspondence Address: NIXON & VANDERHYE, PC, 901 NORTH GLEBE ROAD, 11TH FLOOR, ARLINGTON, VA, 22203, US

(73) Assignees: NIPPON SOKEN, INC., Nishio-city (JP); DENSO CORPORATION, Kariya-city (JP)

(21) Appl. No.: 12/145,917

(22) Filed: Jun. 25, 2008

(30) Foreign Application Priority Data
Jun. 26, 2007 (JP) 2007-167799

(51) Int. Cl. G01N 7/06

(52) U.S. Cl. 73/23.33

(57) ABSTRACT

A gas sensing element for detecting a specified gas concentration in measuring gases is disclosed. The gas sensing element has at least a surface layer portion formed with an alumina composite sintered body having a principal component of alumina. The alumina composite sintered body contains alumina particles and dispersion particles, dispersed in a boundary between the alumina particles or in the alumina particles, which have an average particle diameter smaller than that of the alumina particles. The dispersion particles have particle-to-particle distances with an average of 4 μm or less and a standard deviation of 1.8 or less. The dispersion particles have particle diameters with an average of 0.2 μm or less and a standard deviation of 0.05 or less.

### CROSS REFERENCE TO RELATED APPLICATIONS

This application is based on Japanese Patent Application No. 2007-167799, filed on Jun. 26, 2007, the content of which is hereby incorporated by reference.

### BACKGROUND OF THE INVENTION

1. Field of the invention

The present invention relates to a gas sensing element for detecting a specified gas concentration in measuring gases such as exhaust gases or the like.

2. Description of the Related Art

An internal combustion engine, such as an engine of a motor vehicle, has an exhaust system carrying thereon a gas sensor for measuring a concentration of a specified gas such as oxygen or the like in exhaust gases. The gas sensor incorporates therein a gas sensing element, composed of ceramic, which detects a specified gas concentration in exhaust gases.

The gas sensing element, used in the exhaust system of the internal combustion engine, has a likelihood to suffer from water droplets present in exhaust gases immediately after the engine has started up. With the water droplets adhered, a local area of the gas sensing element is rapidly cooled to suffer a thermal shock, causing an element crack to occur in certain instances.

Japanese Patent Application Publication No. 8-15213 discloses a method of controlling a gas sensing element such that its activity is delayed to prevent an increase in temperature of the gas sensing element until the exhaust gases increase in temperature to remove the water droplets for thereby avoiding the occurrence of thermal shock.

However, if the gas sensing element is delayed in operation until the water droplets are removed from exhaust gases, the specified gas concentration ill exhaust gases cannot be measured immediately after the engine has started up, making it difficult to perform an air/fuel ratio control.

### SUMMARY OF THE INVENTION

The present has been completed with the above view in mind and has an object to provide a gas sensing element having excellent the thermal-shock resistance.

To achieve the above object, an aspect of the present invention provides a gas sensing element for detecting a specified gas concentration in measuring gases, comprising at least a surface layer portion having a layer of an alumina composite sintered body containing a principal component of alumina. The alumina composite sintered body contains alumina particles and dispersion particles, dispersed in a boundary between the alumina particles or in the alumina particles, which have an average particle diameter smaller than that of the alumina particles. The dispersion particles are distanced from each other by particle-to-particle distances with an average of 4 μm or less and a standard deviation of 1.8 or less. The dispersion particles have particle diameters with an average of 0.2 μm or less and a standard deviation of 0.05 or less.

The present invention has various advantageous effects as described below.

The alumina composite sintered body, forming the gas sensing element, contains the dispersion particles which are distributed in a dispersed pattern. Therefore, the alumina composite sintered body, forming at least a surface layer portion of the gas sensing element, has increased mechanical strength, enabling the gas sensing element to have increased thermal-shock resistance.

That is, due to the dispersion particles present on the boundary of the alumina particles, the boundary of the alumina particles is reinforced, resulting in improvement on mechanical strength of the alumina composite sintered body.

Further, the coexistence of the dispersion particles and the alumina particles results in a consequence of suppressing particle growth of the alumina particles, thereby achieving miniaturized refinement of the alumina particles. This allows the alumina composite sintered body to have increased mechanical strength.

Further, with the dispersion particles present in the alumina particles, a compressive residual stress occurs due to a difference in thermal-shock resistances of the alumina particles and the dispersion particles, resulting in an increase in mechanical strength of the alumina composite sintered body.

Furthermore, due to the dispersion particles being dispersed in placement, a crack occurring on the boundary of the alumina particles is caused to deflect or stop at a position in the vicinity of an area in which the dispersion particles are present. Therefore, the alumina composite sintered body is less susceptible to suffer large cracks, thereby obtaining fracture toughness with increased mechanical strength.

However, it is difficult to adequately increase mechanical strength of the alumina composite sintered body by merely causing the dispersion particles to be present on the boundary of the alumina particles or in the same. That is, for instance, under a circumstance where, for instance, the dispersion particles are not adequately dispersed and the dispersion particles are dispersed in a disproportionate pattern (see FIG. 9), an area with the distribution particles dispersed in a sparse pattern does not obtain the beneficial effect resulting from the existence of the dispersion particles. Thus, the alumina composite sintered body may have difficulty in obtaining adequate mechanical strength.

Further, if the dispersion particles have too large particle diameters, the alumina composite sintered body has a fear of easily suffering a crack (see FIG. 8).

To address such an issue, the present invention contemplates the provision of the gas sensing element composed of the alumina composite sintered body. With the alumina composite sintered body, the dispersion particles have the particle-to-particle distance falling in the average of 4 μm or less with the standard deviation of 1.8 or less and the particle diameters falling in the average of 0.2 μm or less with the standard deviation of 0.05 or less.

With the particle-to-particle distance falling in the average of 4 μm or less with the standard deviation of 1.8 or less, the alumina composite sintered body has the dispersion particles dispersed in an adequately distributed pattern. This allows the alumina composite sintered body to have the effect of the dispersion particles dispersed in the adequately distributed pattern, enabling the alumina composite sintered body to have increased mechanical strength.

Further, with the dispersion particles having the particle diameters falling in the average of 0.2 μm or less with the standard deviation of 0.05 or less, the dispersion particles can have adequately minimized particle diameters while suppressing the existence of dispersion particles of a large size. This results in a capability of is adequately suppressing cracks from occurring on the boundary of the alumina particles with a start point on the dispersion particle, thereby enabling the alumina composite sintered body to have increased mechanical strength.

As a result, the gas sensing element, having at least a surface layer made of the alumina composite sintered body, can have improved thermal-shock resistance, enabling the suppression of an element crack due to incursion of water onto the surface.

As set forth above the present invention can provide a gas sensing element having excellent thermal-shock resistance.

### BRIEF DESCRIPTION OF THE DRAWINGS

FIG. 1 is a typical view showing a dispersing state of dispersion particles used for a gas sensing element of an embodiment according to the present invention.

FIG. 2 is a cross sectional view showing the gas sensing element of the embodiment according to the present invention.

FIG. 3 is a cross sectional view showing a gas sensor incorporating the gas sensing element of the embodiment shown in FIG. 2.

FIG. 4 is an illustrative perspective view of a test piece for use in a three-point bend strength test conducted in Example 1.

FIG. 5 is an illustrative view illustrating how the three-point bend strength test is conducted in Example 1.

FIG. 6 shows an SEM photograph on an alumina composite sintered body of a test piece 3 used in Example 1.

FIG. 7 shows an SEM photograph on an alumina composite sintered body with dispersion particles added in a powdered state in Example 1.

FIG. 8 shows an SEM photograph on an alumina composite sintered body of a comparative test piece 1 used in Example 1.

FIG. 9 shows an SEM photograph on an alumina composite sintered body of a comparative test piece 4 used in Example 1.

### DETAILED DESCRIPTION OF THE PREFERRED EMBODIMENTS

Now, a gas sensing element of an embodiment according to the present invention is described below in detail with reference to the accompanying drawings. However, the present invention is construed not to be limited to such an embodiment described below and technical concepts of the present invention may be implemented in combination with other known technologies or the other technology having functions equivalent to such known technologies.

The present invention will be described below with reference to a gas sensing element to be used for a gas sensor The gas sensor may include an A/F sensor adapted to be mounted on an exhaust pipe of various internal combustion engines such as, for instance, motor vehicles for detecting an air/fuel ratio using a limited current value depending on an oxygen concentration in measuring gases such as exhaust gases. The gas sensor may further include an oxygen sensor for measuring an oxygen concentration in exhaust gases or a NOx sensor utilized for detecting deterioration in a three-way catalyst mounted on the exhaust pipe for checking a concentration of air-pollution substance such as NOx or the like. Further, under a circumstance where the average particle-to-particle distance exceeds 4 μm or the related standard deviation exceeds 1.8, the dispersion particles are not adequately dispersed. Thus, there is possibility that due to having the dispersion particles distributed in a sparse pattern, the effect resulting from the existence of the dispersion particles will be reduced and the alumina composite sintered body is difficult to obtain with adequate mechanical strength. Furthermore, under another circumstance where the average particle diameter of the dispersion particles exceeds 0.2 μm and the related standard deviation exceeds 0.05, there is a fear of the alumina composite sintered body easily suffering a crack with a starting point on a dispersion particle formed in a large size and the alumina composite sintered body is difficult to obtain adequate mechanical strength.

Further, as used herein, the term “particle-to-particle distance” refers to, for instance, a value obtained upon conducting the measurement as described below.

That is, three arbitrary cross sections of the alumina composite sintered body are observed using a scanning electron microscope (SEM) provided with a reflected electron detector. All of particle-to-particle distances each between the neighboring dispersion particles in a rectangle region with a dimension of 9 μm long and 12 μm wide on each of the resulting reflected electron images are measured, thereby taking an average of all measured values of the reflected electron image on three cross sections. Thus, the resulting value is regarded to be an average of the particle-to-particle distances.

Further, as used herein, a standard deviation of all measured values on the particle-to-particle distances is regarded to be a standard deviation of the particle-to-particle distances.

Moreover as used herein, the term “particle diameters of the dispersion particles” refers to, for instance, a value obtained upon conducting the measurement as described below.

That is, like the method described above, the three arbitrary cross sections of the alumina composite sintered body are observed using the scanning electron microscope (SEM) provided with the reflected electron detector. All of the particle diameters of the dispersion particles present in the rectangle region with the dimension of 9 μm long and 12 μm wide on each of the resulting reflected electron images are measured, thereby taking an average of all the measured values of the reflected electron image of the three cross sections. Thus, the resulting value is regarded to be an average of the particle diameters.

Further, as used herein, a standard deviation of all measured values on the particle diameters is regarded to be a standard deviation of the particle diameters.

In addition, the particle diameter of each dispersion particle refers to a diameter of a circle having the same surface area as that of the image of each dispersion particle observed as the reflected electron image.

Further, the particle-to-particle distances may preferably have an average of 2 μm or less with a standard deviation of 0.8 or less.

In this case, the alumina composite sintered body can have a further enhanced advantageous effect with increased mechanical strength due to the dispersion particles dispersed in proper distribution.

Furthermore, the dispersion particles may preferably have the particle diameters falling in an average of 0.15 μm or less with a standard deviation of 0.04 or less.

In this case, the alumina composite sintered body can have a further enhanced advantageous effect with increased mechanical strength due to the dispersion particles dispersed in proper distribution. In addition, it becomes possible to effectively preclude the occurrence of crack in the alumina composite sintered body with a start point on the dispersion particle.

The alumina particles may preferably have an average particle diameter of 5 μm or less.

In this case, the existence of the dispersion particles distributed in miniaturized refinement enables the alumina composite sintered body to have increased mechanical strength.

The alumina particles may have an average particle diameter obtained as described below.

That is, the three arbitrary cross sections of the alumina composite sintered body are observed using the scanning electron microscope (SEM) provided with the reflected electron detector All of the particle diameters of the alumina particles present in the rectangle region with the dimension of 9 μm long and 12 μm wide on each of the resulting reflected electron images are measured, thereby taking an average of all the measured values of the reflected electron image on the three cross sections. Thus, the resulting value is regarded to be an average particle diameter of the alumina particles.

Further, the particle diameter of each alumina particle refers to a diameter of a circle having the same surface area as that of the image on each alumina particle observed by the SEM.

Further, the alumina particles may preferably have an average particle diameter of 3 μm or less.

In this case, the alumina particles are formed in further miniaturized refinement, thereby enabling the alumina composite sintered body to have increased mechanical strength.

Furthermore, the alumina composite sintered body may preferably have a content of 1 to 30% by weight of the dispersion particles.

In this case, it becomes possible to adequately obtain an advantageous effect resulting from the dispersion particles dispersed in uniform distribution.

If the content of the dispersion particles is less than 1% by weight, a difficulty is encountered in obtaining the advantageous effect resulting from the dispersion particles dispersed in uniform distribution. Meanwhile, if the content of the dispersion particles exceeds 30% by weight, the advantageous effect resulting from the dispersion particles dispersed in uniform distribution is reduced. In addition, there is a fear of a disadvantage arising with a drop in characteristic such as thermal conductivity of alumina by an extent resulting from a reduction in proportion of the alumina particles.

Moreover, the alumina composite sintered body may preferably have a content of 5 to 20% by weight of the dispersion particles.

In this case, it becomes possible to reliably obtain the advantageous effect resulting from the dispersion particles dispersed in uniform distribution.

Besides, the dispersion particles may preferably be zirconia.

In this case, the alumina composite sintered body can effectively have increased mechanical strength due to the existence of the dispersion particles dispersed in uniform distribution.

Further, the gas sensing element may preferably be of a stack-type gas sensing element comprising a plurality of ceramic layers including the layer of the alumina composite sintered body.

In this case, applying the present invention to the stack type gas sensing element with a peculiar configuration having a tendency to have weakened strength enables an advantageous effect of the present invention to be effectively exhibited in increased enhancement.

### EMBODIMENT

### FIRST EMBODIMENT

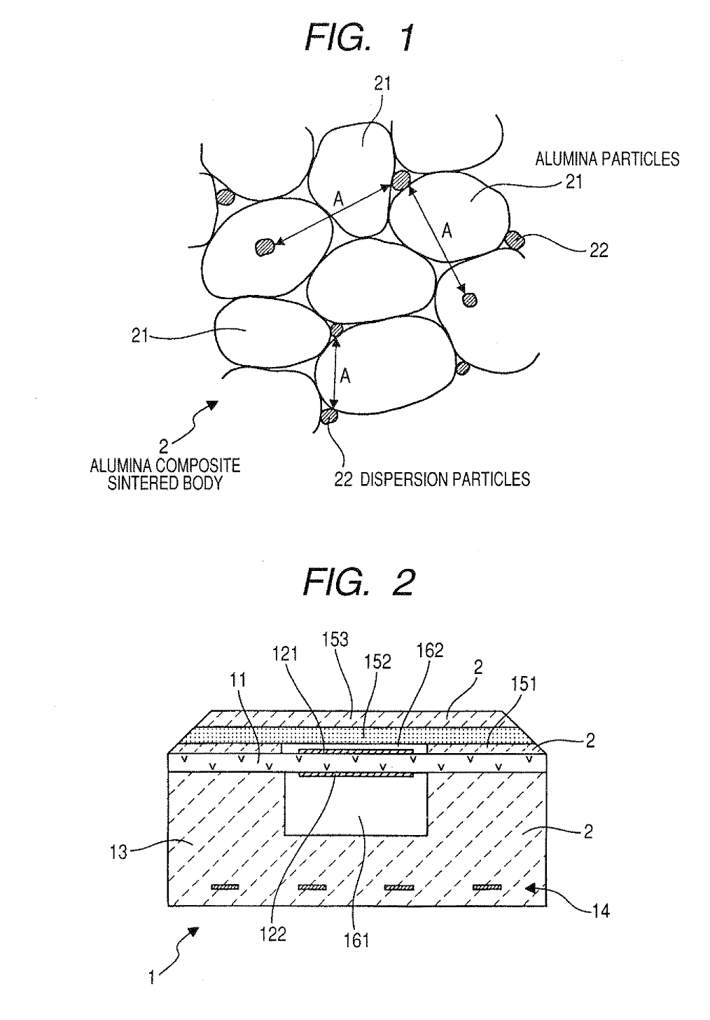

Now, a gas sensing element of a first embodiment according to the present invention will be described below in detail with reference to FIGS. 1 to 3 of the accompanying drawings.

The gas sensing element 1 of the present embodiment is a gas sensing element, detecting a specified gas concentration contained in measuring gases, which has at least a surface layer portion including a layer composed of an alumina composite sintered body 2 made of a principal component of alumina (Al₂O₃).

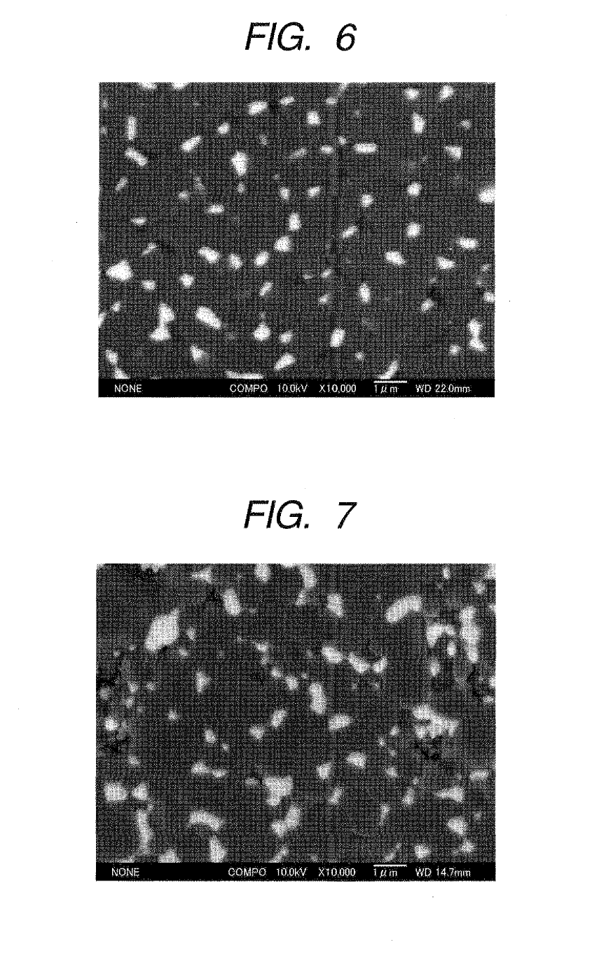

As typically shown in FIG. 1, the alumina composite sintered body 2 is composed of alumina particles 21 and dispersion particles 22 dispersed in boundary regions each between neighboring alumina particles 21 or in the alumina particles 21 per se. The dispersion particles 22 have an average particle diameter less than that of the alumina particles 21 (see FIGS. 6 and 7).

The alumina particles 21 have particle-to-particle distances A, each representing a distance between the neighboring alumina particles 21, which lies in an average value of 4 μm or less with a standard deviation of 1.8 or less.

The dispersion particles 22 have particle diameters with an average of 0.2 μm or less with a standard deviation of 0.05 or less.

Further, the particle-to-particle distances A may preferably have an average of 2 μm or less with a standard deviation of 0.8 or less. Furthermore, the dispersion particles 22 may preferably have an average of 0.15 μm or less with a standard deviation of 0.04 or less.

Furthermore, the alumina particles 21 have an average particle diameter of 5 μm or less and more preferably of 3 μm or less.

Moreover, the alumina composite sintered body 2 has a content of 1 to 30% by weight of the dispersion particles 22 and, more preferably, a content of 5 to 20 by weight of the dispersion particles 22.

In addition, the dispersion particles 22 are comprised of zirconia (ZrO₂).

As shown in FIG. 2, the gas sensing element 1 of the present embodiment is of a stacked type gas sensing element including a plurality of stacked ceramic layers in the form of alumina composite sintered bodies 2.

In particular, the gas sensing element 1 comprises a solid electrolyte body 11 having a principal component of zirconium. The solid electrolyte body 11 has one surface formed with a measuring gas detecting electrode 121 and the other surface formed with a reference gas electrode 122 formed in an area in opposition to the measuring gas detecting electrode 121. A chamber forming layer 13 is stacked on the solid electrolyte body 11 on the same surface as that on which the reference gas electrode 122 is formed. The chamber forming layer 13 has a reference gas chamber 161 formed in face-to-face relation to the reference electrode 122. The chamber forming layer 13 is embedded with a heater 14 having heating elements 14a that can be turned on to develop a heat.

Further, a spacer layer 151 and a porous diffusion resistance layer 152 are stacked on the solid electrolyte body 11 in sequence on the same surface as that on which the measuring gas detecting electrode 121 is formed. The spacer layer 151 has a measuring gas chamber 162 to which measuring gases are admitted in a manner described below.

Furthermore, a shielding layer 153 is stacked on the porous diffusion resistance layer 152 on a surface opposite to that on which the spacer layer 151 is stacked.

With the gas sensing element 1 formed in such a structure, the chamber forming layer 13, including a surface layer in which the heater 14 is embedded, and the 25 shielding layer 153 are comprised of dense alumina composite sintered bodies 2. In addition, the spacer layer 151 is comprised of the dense alumina composite sintered body 2.

Moreover, the porous diffusion resistance layer 152 is comprised of a porous sintered body having a principal component of alumina and formed in a structure to enable measuring gases to permeate in a diffused state. This properly adjusts the rate of measuring gases flowing to the measuring gas detecting electrode 121. This allows the measuring gas detecting electrode 121 to precisely measure a specified gas (such as oxygen or the like).

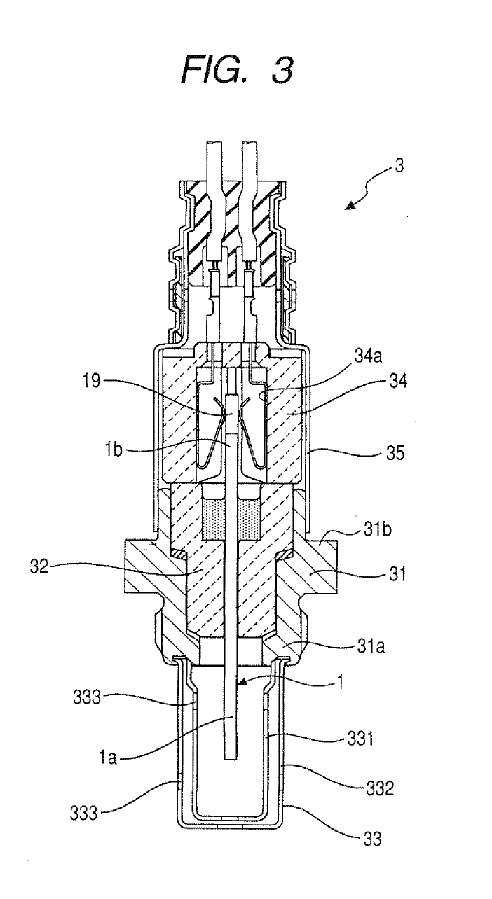

Further, the gas sensing element 1 is incorporated in, for instance, a gas sensor 3 of a structure as shown in FIG. 3.

As show in FIG. 3, the gas sensor 2 comprises a first insulating porcelain 32, fixedly retained with a housing 31 in an inside area thereof, which rigidly supports the gas sensing element 1. The housing 31 has a leading end 31a carrying thereon an element cover 33 for covering a leading end 1a of the gas sensing element 1. The gas sensing element 1 has a base end 1b formed with terminal portions 19 that are covered with a second insulating porcelain 34. The housing 31 also has a base end 31b carrying thereon an atmosphere-side cover 35 covering the second insulating porcelain 34.

The second insulating porcelain 34 is placed on top of the first insulating porcelain 32 and has an inner cavity 34a accommodating therein the terminal portions 19.

As used herein, the term “leading end” refers to an end portion of the gas sensor 3 in a position adapted to be inserted to an exhaust pipe of an internal combustion engine or the like and the term “base end” refers to the other end portion of the gas sensor 3 in opposition to the leading end thereof.

The element cover 33 includes an inner bottomed cover 331 and an outer bottomed cover 332, both of which have base ends connected the leading end 31a of the housing 31. The inner bottomed cover 331 and the outer bottomed cover 332 have gas flow passages 333 through which measuring gases are admitted to an inside of the inner bottomed cover 331.

With the gas sensor 3 having a leading end inserted to the exhaust pipe of the internal combustion engine, the gas sensor 3 is rigidly supported in a fixed position by means of the housing 31.

In measuring a specified gas concentration in measuring gases with the use of the gas sensor of the structure mentioned above, first, the heater 14 is turned on to heat the gas sensing element 1 until the temperature of the gas sensing element 1 rises up to an active temperature. In addition, atmospheric air, acting as reference gas, is introduced into the reference gas chamber 161 and exhaust gases are introduced as measuring gases into the measuring gas chamber 162 via the gas flow passages 333 of the element cover 33 and the porous diffusion resistance layer 152.

Under such a state, a given voltage is applied across the reference gas electrode 122 and the measuring gas detecting electrode 121. When this takes place, an electric current flows through the reference gas electrode 122 and the measuring gas detecting electrode 121 at a limited electric current value based on which an oxygen concentration in measuring gases is detected for measuring an air/fuel ratio of a mixture combusted in the internal combustion engine.

Further, the gas sensor 3 has been discussed above with reference to an exemplary application to an air/fuel sensor. However, the present invention is not limited to such an application and may have other applications to, for instance, an O₂ sensor and a NOx sensor or the like.

In manufacturing the gas sensing element 1 of the present embodiment, the alumina sintered bodies 2 are formed in, for instance, a manner as described below.

That is, zirconia and a dispersant are added to alumina slurry after which these components are mixed together to prepare a mixture. Then, an auxiliary agent such as a binder or the like is further added to the mixture, thereby preparing mixed slurry. In adding zirconia to alumina slurry, zirconia slurry, formed in a slurry state, may be preferably added to alumina slurry. However, in an alternative, zirconia, formed in a powdered state, may be added to alumina slurry.

Next, using a doctor blade method allows mixed slurry to be formed in a sheet-like compact body. Depending on needs, the sheet-like compact body is cut into multiple pieces, which are then stacked on each other, thereby preparing unfired bodies for the s alumina composite sintered bodies 2 that form the chamber forming layer 13, the spacer layer 151 and the shielding layer 153.

Further, these unfired bodies are stacked with other unfired bodies of the other ceramic layers constituting the gas sensing element 1, thereby obtaining an unfired stack body.

Then, the unfired stack body is degreased and, thereafter, is fired, after which the unfired stack body is ground to obtain the gas sensing element 1 containing the alumina composite fired bodies 2.

The gas sensing element 1 of the present embodiment has various advantageous effects as described below.

Each of the alumina composite sintered bodies 2, forming the gas sensing element 1, contains the dispersion particles 22 distributed in a dispersed pattern. The alumina composite sintered bodies 2, forming at least surface layer portions of the gas sensing element 1, have increased mechanical strength, causing the gas sensing element 1 to have increased thermal-shock resistance.

That is, with the dispersion particles 22 present on the boundaries each between the adjacent alumina particles 21, the particle boundaries of the alumina particles 21 are reinforced, resulting in an increase in mechanical strength of the alumina composite sintered body 2.

Further, with the dispersion particles 22 coexistent with the alumina particles 21, particle growths of the alumina particles 21 are suppressed such that the alumina particles 21 are formed in minimized refinement. This results in an increase in mechanical strength of the alumina composite sintered body 2.

With the dispersion particles 22 present in the alumina particles 21, further, a compressive residual stress occurs due to a difference in thermal expansion coefficient between the alumina particle 21 and the dispersion particle 22. This results in an increase in mechanical strength of the alumina composite sintered body 2.

With the dispersion particles 22 distributed in a dispersed pattern, furthermore, a crack occurring on the boundary between the neighboring alumina particles 21 is caused to deflect or stop at a position in close proximity to an area where the dispersion particles 22 are present. Therefore, no large crack is liable to occur in the alumina composite sintered body 2, resulting in an increase in fracture toughness with improved mechanical strength.

However, it is difficult for the alumina composite sintered body 2 to adequately have improved mechanical strength merely by causing the dispersion particles 22 to be present on the boundary of the neighboring alumina particles 21 or in the alumina particles 21 per se. That is, for instance, if the dispersion particles 22 are not adequately dispersed and disproportionately distributed (see FIG. 9), the dispersion particles 22 are dispersed in a sparse distribution pattern in a local area. In such a case, the alumina composite sintered body 2 has no advantageous effect resulting from the existence of the dispersion particles 22, causing a fear to arise with a difficulty of obtaining adequate mechanical strength.

Further, if the dispersion particles 22 have too large particles, it is likely that the alumina composite sintered body 2 easily suffers a crack (see FIG. 5) with a starting point on the dispersion particle 22.

To overcome such defects, with the alumina composite sintered body 2 forming part of the gas sensing element 1 embodying the present invention, the dispersion particles 22 and the alumina particles 21 are determined to have various factors. That is, the particle-to-particle distances A, each representing the distance between neighboring dispersion particles 22, have an average of 4 μm or less with a standard deviation of 1.8 or less. In addition, the dispersion particles 22 have particle diameters with an average of 0.2 μm or less with a standard deviation of 0.05 or less.

With the particle-to-particle distance A having the average of 4 μm or less with the standard deviation of 1.8 or less, the dispersion particles 22 can be placed in the alumina composite sintered body 2 in an adequately dispersed pattern. This allows the alumina composite sintered body 2 to adequately have the advantageous effect resulting from the dispersion particles 22 scattered in the dispersed pattern, enabling the alumina composite sintered body 2 to have adequately increased mechanical strength.

With the dispersion particles 22 having the particle diameters with the average of 0.2 μm or less with the standard deviation of 0.05 or less, further, the dispersion particles 22 have adequately minimized particle diameters, thereby suppressing the existence of dispersion particles in large size. This adequately suppresses the defects such as the crack occurring on the boundary of the alumina particles 21 with the starting point on the dispersion particle 22, enabling the alumina composite sintered body 2 to have adequately increased mechanical strength.

As a result, the gas sensing element 1, having at least the surface layer formed of the alumina composite sintered body 2, can have improved thermal-shock resistance, resulting in a capability of preventing element cracking from occurring due to the incursion of water applied onto the surface.

With the particle-to-particle distance A remained in the average of 2 μm or less with the standard deviation of 0.8 or less, the strength increasing effect of the alumina composite sintered body 2 resulting from the dispersion particles 22 distributed in the dispersed pattern is further enhanced.

With the dispersion particles 22 having the average particle diameter of 0.15 μm or less with the standard deviation of 0.04 or less, the strength increasing effect of the alumina composite sintered body 2 resulting from the dispersion particles 22 distributed in the dispersed pattern is further enhanced. In addition, this effectively prevents the alumina composite sintered body 2 from suffering a crack with a starting point on the dispersion particle 22.

With the alumina particles 21 having the average particle diameter of 5 μm or less, the alumina composite sintered body 2 can have increased mechanical strength due to the existence of the alumina particles 21 formed in miniaturized refinement. In addition, with the alumina particles 21 having the average particle diameter of 3 μm or less, the alumina particles 21 are formed in further miniaturized refinement, thereby enabling the alumina composite sintered body 2 to have further increased mechanical strength.

Further, since the alumina composite sintered body 2 has a content of 1 to 30% by weight of the dispersion particle 22, the alumina composite sintered body 2 can adequately obtain the advantageous effect resulting from the dispersion particle 22 distributed in the dispersed pattern. In addition, with the alumina composite sintered body 2 having a content of 5 to 20% by weight of the dispersion particle 22, the advantageous effect resulting from the dispersion particle 22 distributed in the dispersed pattern can be further reliably obtained.

Furthermore, since the dispersion particle 22 are composed of zirconia, the alumina composite sintered body 2 can effectively have increased mechanical strength due to the existence of the dispersion particle 22 distributed in a dispersed pattern.

Moreover, the gas sensing element 1 is comprised of the stack-type gas sensing element comprised of plural stacked ceramic layers including the layers of the alumina composite sintered bodies 2. Applying the present invention to the stack-type gas sensing element 1 of such a structure liable to have weakened mechanical strength allows the advantageous effect of the present invention to be exhibited in a further effective fashion.

As set forth above, the present embodiment can provide the gas sensing element with increased thermal-shock resistance.

### EXAMPLE 1

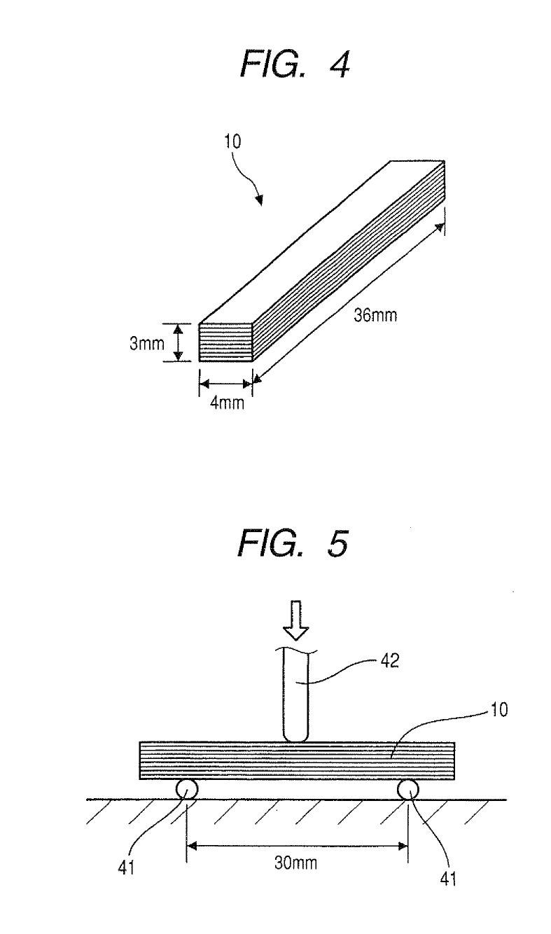

As shown in Table 1 and FIGS. 4 to 9, example 1 represents results of tests conducted to check mechanical strength of the alumina composite sintered bodies 2 prepared with various forms in dispersion states, particle diameters and additive amounts of dispersion particles or in particle diameters of alumina particles in comparison.

That is, as shown in Table 1, test pieces 1 to 5 were prepared as the alumina composite sintered bodies 2 each forming an alumina composite sintered body of a gas sensing element embodying the present invention. Further, comparative test pieces 1 to 8 were prepared as the alumina composite sintered bodies 2 that do not satisfy a condition of the present invention and a comparative test piece 9 was prepared as the alumina composite sintered body 2 in which no dispersion particles are included.

In preparing the alumina composite sintered bodies 2, zirconia and a dispersant were added to alumina slurry to form a mixture, to which an auxiliary agent such as a binder or the like was further added, thereby preparing mixed slurry.

Next, the mixed slurry was formed into a plurality of sheet-like compact bodies by using a doctor blade method. The plural sheet-like compact bodies were stacked on each other, thereby preparing an unfired body of the alumina composite sintered body.

Thereafter, the unfired body was cut into plural pieces each with a given dimension, after which the plural pieces were degreased and fired to obtain the alumina composite sintered bodies. A surface of each alumina composite sintered body was ground to obtain a three-point bend sample 10.

The alumina composite sintered body (comparative test piece 9) was prepared in the same steps as those mentioned above except for a step in which no zirconia was mixed to the mixed slurry.

Further, during the manufacturing method described above, various test pieces were prepared upon varying the additive amounts of zirconia. Furthermore, the dispersing states of the dispersion particles, composed of zirconia, were prepared in various dispersion patterns by varying the kind of dispersants and additive amounts thereof Moreover, in conducting methods of adding zirconia to alumina slurry, the dispersing states of zirconia may be varied even by adding zirconia slurry, prepared in a slurry state, to alumina slurry or by adding powdered zirconia to alumina slurry. The test pieces 1 to 5 and the comparative test pieces 1 to 8 were prepared in the manner as mentioned above with test results being represented in Table 1. In addition, the alumina sintered body was prepared as the test piece 9 with no inclusion of zirconia.

After the alumina composite sintered bodies of various kinds have been prepared, the dispersing states of the dispersion particles were checked. That is, an average and a standard deviation of particle-to-particle distances, each representing a distance between neighboring dispersion particles, and an average and a standard deviation of particle diameters of the dispersion particles were measured and calculated.

That is, three arbitrary cross sections of each alumina composite sintered body were observed using a scamming electron microscope (SEM) provided with a reflected electron detector. All of the particle-to-particle distances A (see FIG. 1) each representing a distance between the neighboring dispersion particles in a rectangle region with a dimension of 9 μm long and 12 μm wide on each of reflected electron images were measured, thereby taking an average of all the measured values of the reflected electron images on the three cross sections. The resulting value was regarded to be an average of the particle-to-particle distances A.

Further, a standard deviation in all the measured values of the particle-to-particle distances A was regarded to be a standard deviation of the particle-to-particle distances A described above.

Further, the particle diameters of the dispersion particles represent values measured in a manner as described below.

Like the steps discussed above, the three arbitrary cross sections of each alumina composite sintered body were observed using the scanning electron microscope (SEM) provided with the reflected electron detector. All of the particle diameters of the dispersion particles present in the rectangle region with the dimension of 9 μm long and 12 μm wide on each reflected electron image were measured, thereby taking an average of all the particle diameters of the reflected electron images on the three cross sections. The resulting value was regarded to be an average of the particle diameters of the dispersion particles.

Furthermore, a standard deviation in all the measured values of the particle diameters was regarded to be a standard deviation of the particle diameters.

Moreover, the particle diameter of the dispersion particle was regarded to be a diameter of a circle having the same surface area as that of an image on the dispersion particle observed as the reflected electron image.

Further, the particle diameters of the alumina particles were measured in a manner described below.

That is, the three arbitrary cross sections of each alumina composite sintered body were observed using the scanning electron microscope (SEM) provided with the reflected electron detector. All of the particle diameters of the alumina particles present in the rectangle region with the dimension of 9 μm long and 12 μm wide on each resulting SEM image, thereby taking an average of all the particle diameters of the SEM images on the three cross sections. The resulting value was regarded to be an average particle diameter of the alumina particles.

Moreover, the particle diameter of the alumina particle was regarded to be a diameter of a circle having the same surface area as that of an image on the alumina particles observed in the SEM image.

Then, three-point bend mechanical strength were measured on the test pieces 1 to and the comparative test pieces 1 to 9 using a three-point bend test method specified under JIS R1601.

That is, first, as shown in FIG. 4, each of the test pieces was configured to form a test piece 10 with a nearly rectangular solid shape that is 36 mm long, 4 mm wide and 3 mm height. In addition, sheet compact bodies are stacked on each other in a direction along a height direction.

As shown in FIG. 5, further, the test piece 10 was placed on two fulcrum points 41 spaced from each other by a distance of 30 mm with the height direction arranged in a vertical direction and a longitudinal direction of the test piece 10 aligned on a horizontal plane. Under such a condition, a press jig 42 was brought into contact with the test piece 10 at a center position thereof in an area between the two fulcrum points 41, after which the press jig 42 was pressed against the test piece 10 from an upper area thereof to a lower area in the vertical direction. During such pressing movement, a pressing load was caused to progressively increase until the test piece 10 was broken down at a maximal load, on which three-point bend mechanical strength was measured. In addition, during such a test, the press jig 42 was lowered at a speed of 0.5 mm/min.

Measured results are indicated on Table 1.

TABLE 1

| | | | | | Amount | Diam- | |
|---|---|---|---|---|---|---|---|
| | Particle-to- | | Diameter of | | (% by | eter | Three- |
| | particle | | Dispersion | | weight) | (μm) of | point |
| | Distance | | Particles | | of | Alu- | Bend |
| | Aver. | Stand. | Aver. | Stand. | Disper. | mina | Strength |
| | (μm) | Devia. | (μm) | Devia. | Parti. | Parti. | (MPa) |
| Test | 1.80 | 0.79 | 0.12 | 0.03 | 5.0 | 1.85 | 745 |
| Piece | | | | | | | |
| 1 | | | | | | | |
| Test | 1.46 | 0.60 | 0.13 | 0.04 | 10.0 | 1.29 | 923 |
| Piece | | | | | | | |
| 2 | | | | | | | |
| Test | 1.65 | 0.62 | 0.13 | 0.04 | 14.2 | 1.13 | 836 |
| Piece | | | | | | | |
| 3 | | | | | | | |
| Test | 3.29 | 1.74 | 0.12 | 0.03 | 2.0 | 1.54 | 668 |
| Piece | | | | | | | |
| 4 | | | | | | | |
| Test | 3.99 | 1.71 | 0.13 | 0.04 | 2.0 | 4.23 | 596 |
| Piece | | | | | | | |
| 5 | | | | | | | |
| Compar. | 4.48 | 1.91 | 0.21 | 0.06 | 15.6 | 1.89 | 382 |
| Test | | | | | | | |
| Piece | | | | | | | |
| 1 | | | | | | | |
| Compar. | 4.66 | 2.15 | 0.16 | 0.06 | 10.0 | 7.32 | 350 |
| Test | | | | | | | |
| Piece | | | | | | | |
| 2 | | | | | | | |
| Compar. | 3.91 | 1.72 | 0.16 | 0.08 | 15.6 | 6.36 | 328 |
| Test | | | | | | | |
| Piece | | | | | | | |
| 3 | | | | | | | |
| Compar. | 3.09 | 1.62 | 0.14 | 0.07 | 14.2 | 6.65 | 341 |
| Test | | | | | | | |
| Piece | | | | | | | |
| 4 | | | | | | | |
| Compar. | 2.79 | 1.45 | 0.16 | 0.07 | 14.2 | 3.87 | 314 |
| Test | | | | | | | |
| Piece | | | | | | | |
| 5 | | | | | | | |
| Compar. | 2.82 | 1.38 | 0.16 | 0.06 | 12.1 | 5.31 | 321 |
| Test | | | | | | | |
| Piece | | | | | | | |
| 6 | | | | | | | |
| Compar. | 2.40 | 1.26 | 0.24 | 0.26 | 10.0 | 4.22 | 334 |
| Test | | | | | | | |
| Piece | | | | | | | |
| 7 | | | | | | | |
| Compar. | 2.32 | 1.44 | 0.20 | 0.17 | 7.5 | 7.15 | 368 |
| Test | | | | | | | |
| Piece | | | | | | | |
| 8 | | | | | | | |
| Compar. | — | — | — | — | — | 4.21 | 477 |
| Test | | | | | | | |
| Piece | | | | | | | |
| 9 | | | | | | | |

As will be apparent from Table 1, it is turned out that the comparative test piece 9, in which no dispersion particle (zirconia) is added, had three-point bend mechanical strength of 477 MPa whereas the test pieces 1 to 5, satisfying the condition of the present invention, had remarkably improved three-point bend mechanical strength as high as 596 MPa or more.

Further, it is also turned out that the test pieces 1 to 3, satisfying the condition in which the particle-to-particle distances each between the neighboring dispersion particles had an average of 2 μm or less with a standard deviation of 0.8 or less, had remarkably increased three-point bend mechanical strength as high as 745 MPa or more.

In contrast, the comparative test pieces 1 to 8, in which the dispersing states and the particle diameters of the dispersion particles did not satisfy the condition of the present invention, had lower three-point mechanical strength than that of the comparative test piece 9. It is considered that when adding the dispersion particles to alumina, if the dispersion particles are not added to alumina in a proper way, then, a drop occurs in mechanical strength because of the occurrence of cracks starting from points on the dispersion particles.

FIGS. 6 to 9 show SEM photographs on the alumina composite sintered bodies. In these Figures, relatively white portions represent the dispersion particles (zirconia) and relatively black portions represent the alumina particles.

FIG. 6 shows the SEM photograph on the alumina composite sintered body of the test piece 3. The test piece 3 was prepared by adding zirconia to alumina upon preparing zirconia in a slurry state. As will be apparent from FIG. 6, the test piece 3 has a structure in which the dispersion particles are uniformly dispersed with a less variation in particle diameters of the dispersion particles.

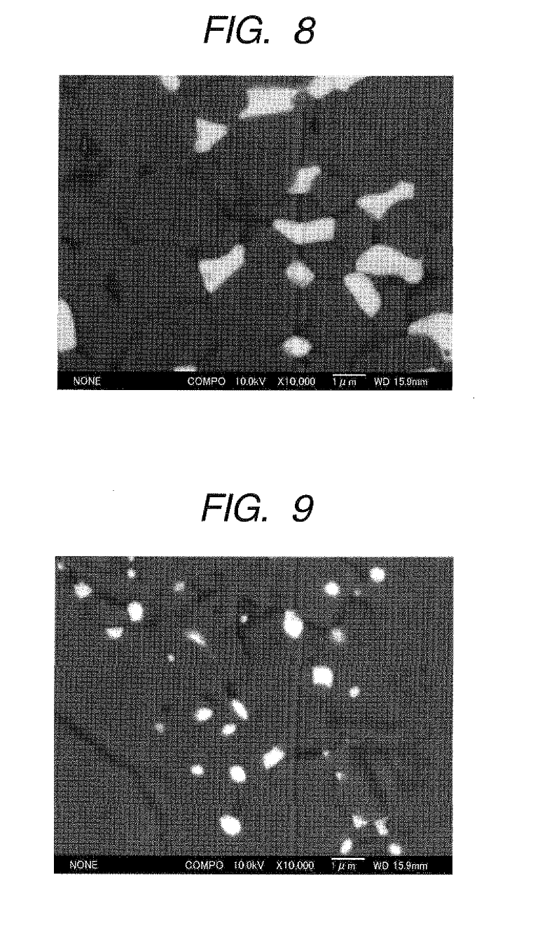

Further, FIG. 7 shows a composition similar to that of the test piece 3 to represent a structure in which zirconia was added to alumina upon preparing zirconia in a powdered state. As will be apparent from FIG. 7, the alumina composite sintered body of this test piece had the dispersion particles, less uniform in dispersing state than that of the dispersion particles of the test piece 3 (see FIG. 6), and the particle diameters appearing in a slightly varying range. The alumina composite sintered body of this test piece had zirconia distributed in an adequately and uniformly dispersing state and particle diameters in contrast to those of the comparative test pieces (see FIGS. 8 and 9) described below.

Furthermore, FIG. 8 is a SEM photograph on the alumina composite sintered body of the comparative test piece 1. As will be apparent from FIG. 8, the comparative test piece 1 had the dispersion particles having large particle diameters.

Moreover, FIG. 9 is a SEM photograph on the alumina composite sintered body of the comparative test piece 4. As will be apparent from FIG. 9, the comparative test piece 4 has the dispersion particles remaining under a nonuniform dispersing state in which there are large areas with no existence of the dispersion particles.

### EXAMPLE 2

As shown in Table 2, this example 2 represents a result on thermal-shock tests using the test piece 3 and the comparative test piece 9 indicated in example 1.

In this example, alumina composite sintered bodies (alumina sintered bodies), each incorporating a heater, were prepared with the heater incorporated between plural stacked sheet compact bodies. That is, a heater pattern was printed on a surface of one sheet compact body using platinum paste and, subsequently, the other sheet compact body was stacked so as to cover the heater pattern. In addition, the test piece 3 and the comparative test piece 9 were prepared using the same structures as those of the sheet compact bodies of the test piece 3 and the comparative test piece 9 prepared in the example 1.

The respective test pieces had nearly rectangular solid shapes each with an outer shape that was 46 mm long, 5 mm wide and 1 mm height.

As shown in Table 2, thermal-shock tests were conducted in a method of heating the test pieces at preset temperatures ranging from 100° C. to 1000° C. with an interval of 100° C. and confirming whether or not the test pieces suffered cracks due to thermal shocks arising when dipped in water at a room temperature.

That is, first, the heater was turned on to heat each test piece such that each test piece was raised in temperature from 100° C. to various preset temperatures in stepwise maimer for two minutes in each temperature. Under such a state, the heater was turned off and concurrently a distal end portion (in a length of about 5 mm) of each test piece was dipped in water.

Subsequently, each test piece was pulled up from water and water was wiped away from each test piece, after which the heater was turned on again to check the presence or absence of the occurrence of a spark discharge.

If no spark discharge was observed, the temperature of the test piece was raised to the next preset temperature and similar operations were conducted.

Such operational steps were carried out until the spark discharge was observed or repeatedly conducted until the preset temperature reached 1000° C.

Two samples for each of the test pieces (the test piece 3 and the comparative test piece 9) were prepared for the above tests with a number “n” assigned to be 2.

Test results are indicated in Table 2. In Table 2, a symbol “o” represents the absence of the spark discharge when turning on the heater after the sample was dipped in water at respective preset temperatures and a symbol “x” represents the occurrence of the spark discharge.

TABLE 2

| | | |
|---|---|---|
| Preset | | |
| Temperatures | Comparative Test Piece 9 | Test Piece 3 |

| (° C.) | 1 | 2 | 1 | 2 |
|---|---|---|---|---|
| 100 | ∘ | ∘ | ∘ | ∘ |
| 200 | ∘ | ∘ | ∘ | ∘ |
| 300 | ∘ | ∘ | ∘ | ∘ |
| 400 | ∘ | ∘ | ∘ | ∘ |
| 500 | x | x | ∘ | ∘ |
| 600 | | | ∘ | ∘ |
| 700 | | | ∘ | ∘ |
| 800 | | | ∘ | ∘ |
| 900 | | | ∘ | ∘ |
| 1000 | | | ∘ | ∘ |

As indicated in Table 2, the occurrence of the spark discharge was observed on the comparative test piece 9 at the preset temperature of 500° C. The spark discharge occurred at disconnected portion resulting from the crack occurring in the alumina composite sintered body due to the thermal shock with a disconnection occurring in a heater wire in the existence of the thermal shock. Accordingly, the comparative test piece 9 suffered a large crack at the preset temperature of 500° C.

On the contrary, no occurrence of the spark discharge was observed in the test piece 3 even if the thermal-shock tests were repeatedly conducted up to the preset temperature of 1000° C. That is, the test piece 3 suffered no large crack.

Finally, crack situations of the comparative test piece 9, on which the spark discharge was observed, and the test piece 3, subjected to the repeated tests until the temperature was raised up to the preset temperature of 1000° C., were observed using a color check method employing dye.

Then, the comparative test piece 9 was observed with a crack that penetrated from is a front surface of the comparative test piece 9 to a rear surface thereof. An area in which the crack overlapped the heater wire matched a portion on which the spark discharge was observed.

Further, even though the test piece 3 had front and rear surfaces suffered with fine cracks, respectively, no crack penetrating from the front surface to the rear surface was observed.

From the foregoing results, the test piece 3 satisfying the condition of the present invention was confirmed to reliably have further increased thermal-shock resistance than that the comparative test piece 9.

Although the present invention has been described with reference to the specific embodiment shown in the drawings, it will be appreciated that the particular arrangement disclosed is meat to be illustrative only and not limiting to the scope of the present invention.

What is claimed is:

1. A gas sensing element for detecting a specified gas concentration in measuring gases, comprising:
at least a surface layer position having a layer of an alumina composite sintered body containing a principal component of alumina;
wherein the alumina composite sintered body contains alumina particles and dispersion particles, dispersed in a boundary between the alumina particles or in the alumina particles, which have an average particle diameter smaller than that of the alumina particles;
wherein the dispersion particles are distanced from each other by particle-to-particle distances with an average of 4 μm or less and a standard deviation of 1.8 or less; and
wherein the dispersion particles have particle diameters with an average of 0.2 μm or less and a standard deviation of 0.05 or less.

2. The gas sensing element according to claim 1, wherein:
the particle-to-particle distances have the average of 2 μm or less with the standard deviation of 0.8 or less.

3. The gas sensing element according to claim 1, wherein:
the dispersion particles have the particle diameters with the average of 0.15 μm or less with the standard deviation of 0.04 or less.

4. The gas sensing element according to claim 1, wherein:
the alumina particles have an average particle diameter of 5 μm or less.

5. The gas sensing element according to claim 1, wherein:
the alumina particles have an average particle diameter of 3 μm or less.

6. The gas sensing element according to claim 1, wherein:
the alumina composite sintered body has a content of 1 to 30% by weight of the dispersion particles.

7. The gas sensing element according to claim 1, wherein:
the alumina composite sintered body has a content of 5 to 20% by weight of the dispersion particles.

8. The gas sensing element according to claim 1, wherein:
the dispersion particles are zirconia.

9. The gas sensing element according to claim 1, comprising:
a stack-type gas sensing element composed of a plurality of ceramic layers including the layer of the alumina composite sintered body.

10. The gas sensing element according to claim 1, comprising:
a stack-type gas sensing element including:
a chamber layer composed of the alumina composite sintered body and having a reference gas chamber;
a solid electrolyte layer stacked on the chamber layer and having one surface formed with a reference gas electrode exposed to the reference gas chamber and the other surface formed with a measuring gas detecting electrode;
a spacer layer stacked on the solid electrolyte layer and having a measuring gas chamber to which the measuring gas detecting electrode is exposed;
a porous diffusion resistance layer stacked on the spacer layer; and a shielding layer stacked on the porous diffusion resistance layer;
wherein each of the chamber layer, the spacer layer and the shielding layer is comprised of the alumina composite sintered body.
